(19) United States
(12) Patent Application Publication
(10) Pub. No.: US 2024/0381158 A1
(43) Pub. Date: Nov. 14, 2024

(54) ALTERNATIVE DEVICES FOR POWERING BACKSCATTER DEVICES

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Amine CHOUKIR, Ecublens (CH); Pascal THUBERT, Roquefort Les Pins (FR); Leo CALDAROLA, Morrens (CH)

(21) Appl. No.: 18/430,623

(22) Filed: Feb. 1, 2024

Related U.S. Application Data
(60) Provisional application No. 63/501,640, filed on May 11, 2023.

(51) Int. Cl. H04W 28/02; H04W 64/00; H04W 76/20

(52) U.S. Cl. CPC H04W 28/0221; H04W 64/003; H04W 76/20

(57) ABSTRACT

The present disclosure describes a wireless network in which an access point determines and selects alternative devices to make transmissions for energy harvesting purposes. The access point includes a memory and a processor communicatively coupled to the memory. The processor determines, based on a proximity of a first device to a second device, that the second device should harvest energy from a message transmitted by the first device, determines a first basic service set (BSS) color that the first device and the second device should use for the second device to harvest energy from the message, and communicates, to the first device, an instruction to use the first BSS color when transmitting the message.

### CROSS-REFERENCE TO RELATED APPLICATIONS

This application claims benefit of co-pending U.S. provisional patent application Ser. No. 63/501,640 filed May 11, 2023. The aforementioned related patent application is herein incorporated by reference in its entirety.

### TECHNICAL FIELD

Embodiments presented in this disclosure generally relate to wireless communication. More specifically, embodiments disclosed herein relate to determining and selecting alternative devices to power backscatter devices.

### BACKGROUND

Backscatter devices (BKDs) (which may also be referred to as ambient power devices (AMPs)) harvest electrical energy from wireless signals in the environment (e.g., transmitted by access points). The BKDs then store and use the harvested energy to power themselves. Energy in the wireless signals, however, falls off exponentially with distance. As a result, BKDs may not harvest sufficient energy the further away the BKDs are positioned from transmitting access points. Moreover, in existing networks, messages that are transmitted from non-BKDs to BKDs for energy harvesting purposes also consume bandwidth that could be used for other data transmissions.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example access point or device in the system of FIG. 1.

FIG. 3 illustrates an example operation performed by the system of FIG. 1.

FIG. 4 illustrates an example operation performed by the system of FIG. 1.

FIG. 5 illustrates an example operation performed by the system of FIG. 1.

FIG. 6 is a flowchart of an example method performed by the system of FIG. 1.

FIG. 7 illustrates an example operation performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a wireless network in which an access point determines and selects alternative devices to make transmissions for energy harvesting purposes. According to an embodiment, an access point includes a memory and a processor communicatively coupled to the memory. The processor determines, based on a proximity of a first device to a second device, that the second device should harvest energy from a message transmitted by the first device, determines a first basic service set (BSS) color that the first device and the second device should use for the second device to harvest energy from the message, and communicates, to the first device, an instruction to use the first BSS color when transmitting the message.

According to another embodiment, a method includes determining, based on a proximity of a first device to a second device, that the second device should harvest energy from a message transmitted by the first device, determining a first BSS color that the first device and the second device should use for the second device to harvest energy from the message, and communicating, to the first device, an instruction to use the first BSS color when transmitting the message.

According to another embodiment, a device includes a memory and a processor communicatively coupled to the memory. The processor determines a first congestion level of a first link with a first access point, determines a second congestion level of a second link with a second access point, and based on comparing the first congestion level with the second congestion level, transmits, using the first link rather than the second link, a message from which another device harvests energy.

### Example Embodiments

The present disclosure describes a wireless network (e.g., a wireless fidelity (WiFi) network) in which access points determine and use alternative devices and alternative basic service set (BSS) colors to transmit messages for energy harvesting purposes. For example, devices in the network may report their battery levels and positions to an access point. The access point may then determine which devices need to harvest energy and the proximity of those devices to other devices in the network. The access point may use the proximity to determine which devices may serve as buddy devices and transmit messages to the devices that need to harvest energy. The access point may also determine a BSS color that the buddy devices should use to transmit the messages used for energy harvesting. The buddy devices may then use that BSS color to transmit the energy harvesting messages, while another BSS color is used for data transmissions.

In certain embodiments, the wireless network provides several technical advantages. For example, the access point may increase the amount of energy available for devices to harvest. As another example, the access point may reduce the impact of energy harvesting messages on data transmissions by having the energy harvesting messages be transmitted using a different BSS color.

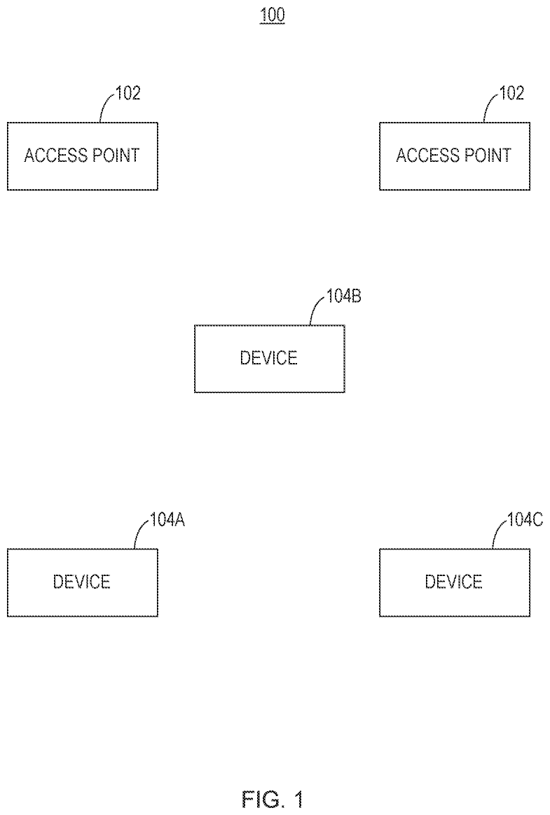

FIG. 1 illustrates an example system 100. Generally, the system 100 may be a wireless network (e.g., a wireless fidelity (WiFi) network). As seen in FIG. 1, the system 100 includes one or more access points 102 and one or more devices 104. In the example of FIG. 1, the system 100 includes devices 104A, 104B, and 104C. Generally, the devices 104 connect to the access points 102. The access points 102 provide network coverage for the system 100. The access points 102 communicate messages to the devices 104 and direct messages from the devices 104 towards their destinations.

An access point 102 facilitates wireless communication in the system 100. One or more devices 104 may connect to the access point 102. The access point 102 may then facilitate wireless communication for the connected devices 104. For example, the access point 102 may transmit messages to a connected device 104. As another example, the access point 102 may receive messages transmitted by the device 104. The access point 102 may then direct that message towards its intended destination.

A device 104 may be any suitable device that wirelessly connects to the access point 102. As an example and not by way of limitation, the device 104 may be a computer, a laptop, a wireless or cellular telephone, an electronic notebook, a personal digital assistant, a tablet, a sensor, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

Some devices 104 in the system 100 may be BKDs that harvest energy from wireless signals in the system 100. These devices 104 then store and use that energy to perform the functions or features of the devices 104. In existing systems, the BKDs typically harvest energy from wireless signals transmitted by the access points. The amount of energy in the wireless signals, however, falls off exponentially with distance from the access points. Thus, the BKDs that are positioned further away from the access points may not harvest enough energy to function properly.

In the system 100, an access point 102 may determine when a device 104 is too far from the access point 102 to effectively harvest energy from wireless signals transmitted by the access point 102. The access point 102 may determine another device (e.g., another access point 102 or another device 104) that is closer to the device 104. The access point 102 may then instruct the other device to transmit wireless signals from which the device 104 harvests energy. For example, the access point 102 may determine that the device 104A is too far from the access point 102 to effectively harvest energy from wireless signals transmitted by the access point 102. The access point 102 may then determine that the device 104B is closer to the device 104A. In response, the access point 102 may instruct the device 104B to transmit wireless signals from which the device 104A harvest energy. The device 104A then stores and uses the harvested energy to perform functions or features of the device 104A. In this manner, the access point 102 allows alternative devices in the system 100 to provide wireless energy for BKDs.

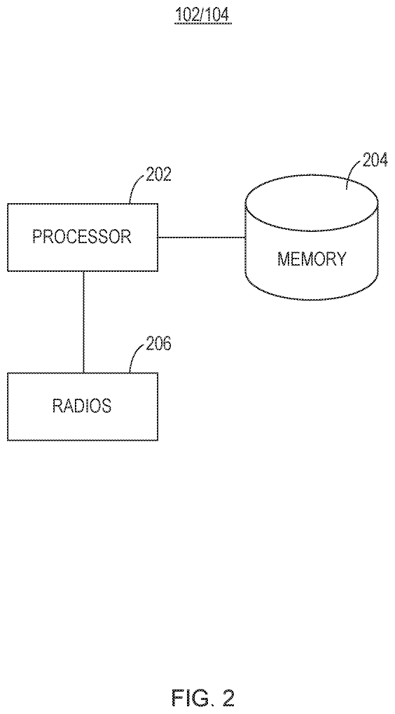

FIG. 2 illustrates an example access point 102 or device 104 in the system of FIG. 1. As seen in FIG. 2, the access point 102 or device 104 includes a processor 202, a memory 204, and one or more radios 206, which may perform the functions or actions of the access point 102 or device 104 described herein.

The processor 202 is any electronic circuitry, including, but not limited to one or a combination of microprocessors, microcontrollers, application specific integrated circuits (ASIC), application specific instruction set processor (ASIP), and/or state machines, that communicatively couples to the memory 204 and controls the operation of the access point 102 or device 104. The processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 202 may include other hardware that operates software to control and process information. The processor 202 executes software stored on the memory 204 to perform any of the functions described herein. The processor 202 controls the operation and administration of the access point 102 or device 104 by processing information (e.g., information received from the access points 102, devices 104, memory 204, and radios 206). The processor 202 is not limited to a single processing device and may encompass multiple processing devices contained in the same device or computer or distributed across multiple devices or computers. The processor 202 is considered to perform a set of functions or actions if the multiple processing devices collectively perform the set of functions or actions, even if different processing devices perform different functions or actions in the set.

The memory 204 may store, either permanently or temporarily, data, operational software, or other information for the processor 202. The memory 204 may include any one or a combination of volatile or non-volatile local or remote devices suitable for storing information. For example, the memory 204 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 204, a disk, a CD, or a flash drive. In particular embodiments, the software may include an application executable by the processor 202 to perform one or more of the functions described herein. The memory 204 is not limited to a single memory and may encompass multiple memories contained in the same device or computer or distributed across multiple devices or computers. The memory 204 is considered to store a set of data, operational software, or information if the multiple memories collectively store the set of data, operational software, or information, even if different memories store different portions of the data, operational software, or information in the set.

The radios 206 may wirelessly communicate with devices 104 or access points 102 in the system 100. The radios 206 may transmit and receive messages wirelessly from the devices 104 or access points 102. Some of the radios 206 may be arranged to transmit messages, while other radios 206 are arranged to receive messages. In some embodiments, the devices 104 may harvest energy from the messages wirelessly received from the radios 206. The devices 104 may store and use the harvested energy to perform the functions or features of the devices 104.

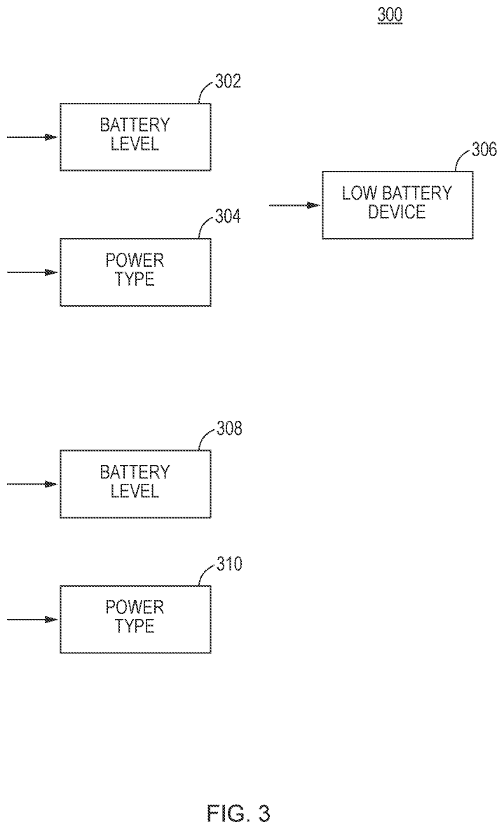

FIG. 3 illustrates an example operation 300 performed by the system 100 of FIG. 1. In certain embodiments, the access point 102 performs the operation 300. By performing the operation 300, the access point 102 determines which devices 104 need to harvest energy.

The access point 102 receives, from devices 104 in the system 100, indications of the battery level and the power type of each device 104. For example, the device 104A may communicate to the access point 102 a battery level 302 of the device 104A and a power type 304 of the device 104A. The device 104B may communicate to the access point 102 a battery level 308 of the device 104B and a power type 310 of the device 104B.

The battery levels 302 and 308 may indicate how much energy each the devices 104A and 104B has available to perform functions or features. The battery levels 302 and 308 may specify a voltage provided by a battery or capacitor in the devices 104A and 104B. The battery levels 302 and 308 may include a percentage indicating how full or empty the battery or capacitor is. The power type 304 and 310 indicate how the devices 104A and 104B are powered. For example, the power type 304 may indicate that the device 104A is a BKD that harvests energy from wireless signals. As another example, the power type 310 may indicate that the device 104B is powered using a battery, plug-in, Ethernet, etc.

The access point 102 may use the battery levels 302 and 308 and the power types 304 and 310 to determine which devices 104 need to harvest energy from wireless signals in the system 100. For example, the access point 102 may analyze the battery levels 302 and 308 to determine that the device 104A is a low battery device 306, which may indicate that the device 104A is running low on energy. The access point 102 may also analyze the power type 304 to determine that the device 104A is a BKD that gains energy by harvesting energy from wireless signals. Based on this information, the access point 102 may determine that the device 104A should begin harvesting energy from wireless signals to increase stored energy.

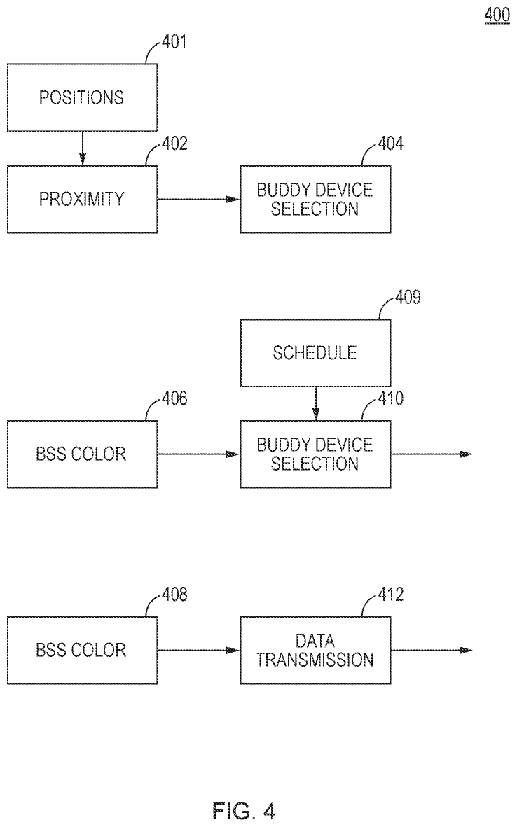

FIG. 4 illustrates an example operation 400 performed by the system 100 of FIG. 1. In certain embodiments, the access point 102 performs the operation 400. By performing the operation 400, the access point 102 determines a buddy device to transmit wireless messages for energy harvesting purposes while reducing the impact on data transmissions.

Continuing from the previous example, the access point 102 may have determined that the device 104A should begin harvesting energy from wireless signals. The access point 102 may receive or determine the positions 401 of the devices 104 in the system 100. For example, the access point 102 may use received signal strength indicators (RSSIs), fine timing measurement (FTM) exchanges, or any other process to determine the positions 401 of the devices 104 in the system 100. From these positions 401, the access point 102 determines the proximity 402 of the devices 104 to each other. For example, the access point 102 may determine how close the device 104A is to other devices 104B and 104C in the system 100. The access point 102 may then make a buddy device selection 404 according to the proximity 402.

As an example, the access point 102 may use RSSI values or FTM exchanges to determine the positions 401 of the devices 104A, 104B, and 104C in the system 100. The access point 102 may then determine, from these positions 401, the proximity 402 of the devices 104A, 104B, and 104C to each other. From the proximity 402, the access point 102 may determine that the access point 102 is too far from the device 104A and that the device 104A should avoid harvesting power from wireless signals transmitted by the access point 102. The access point 102 may also determine that the device 104B is closer to the device 104A than the device 104C is. In response, the access point 102 selects the device 104B as the buddy device that will transmit wireless signals from which the device 104A harvests energy.

To reduce the impact that transmitting the wireless signals has on other data transmissions in the system 100 (e.g., due to bandwidth consumption), the access point 102 may have the wireless signals be transmitted using other BSS colors. For example, in response to determining that the device 104A should harvest energy, the access point 102 may determine a BSS color 406 that should be used for transmitting the wireless signals from which the device 104A harvests energy. The access point 102 then generates and communicates an instruction 410 indicating the BSS color 406. The access point 102 may communicate the instruction 410 to the device 104B to instruct the device 104B to use the BSS color 406 to transmit wireless signals from which the device 104A harvests energy. Additionally, the access point 102 may communicate the instruction 410 to the device 104A to instruct the device 104A to harvest energy from wireless signals transmitted using the BSS color 406. In some embodiments, the access point 102 communicates the instruction 410 to access points 102 and other devices 104 in the system 100 to inform the access points 102 and the other devices 104 that wireless signals will be transmitted using the BSS color 406 for energy harvesting purposes. The access points 102 and other devices 104 may then adjust their transmissions accordingly to reduce interference.

The access point 102 may determine a BSS color 408 that is different from the BSS color 406. The access point 102 may then make a data transmission 412 using the BSS color 408. Because the data transmission 412 is made using a different BSS color 408 than the BSS color 406 used for transmitting wireless signals from which the device 104A harvests energy, the access point 102 reduces the impact that the wireless signals have on the data transmission 412. For example, the wireless signals do not compete with the data transmission 412 for bandwidth. As a result, the device 104B may transmit the wireless signals at the same time as the access point 102 makes the data transmission 412.

In some embodiments, the access point 102 also determines a time when the device 104B should transmit the wireless signals from which the device 104A harvests energy. For example, the access point 102 may schedule the transmission of the wireless signals when there are minimal transmission occurring in the system 100. The access point 102 generates a schedule 409 that indicates the time or times when the device 104B should transmit the wireless signals. The access point 102 may include the schedule 409 in the instruction 410 that is communicated to the device 104B and/or the device 104A. Alternatively or additionally, the access point 102 may communicate the schedule 409 separately from the instruction 410. The device 104B may use the schedule 409 to determine when to transmit the wireless signals. The device 104A may use the schedule 409 to determine when to expect the wireless signals and/or when to harvest energy from the wireless signals.

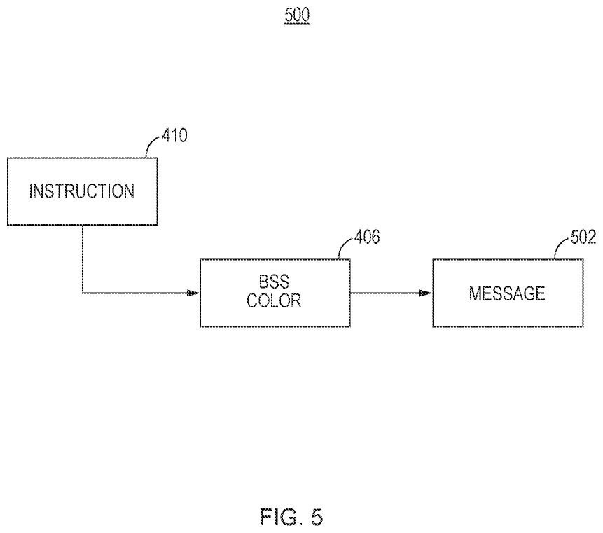

FIG. 5 illustrates an example operation 500 performed by the system 100 of FIG. 1. In certain embodiments, the device 104B performs the operation 500. By performing the operation 500, the device 104B acts as a buddy device and transmits wireless signals from which the device 104A harvests energy.

The device 104B receives the instruction 410 communicated by the access point 102. The instruction 410 may indicate the BSS color 406 that the device 104B should use to transmit wireless signals from which the device 104A harvests energy. In some embodiments, the instruction 410 also indicates a schedule for transmitting the wireless signals. The device 104B determines the BSS color 406 from the instruction 410. The device 104B then generates a message 502 and transmits the message 502 using the BSS color 406. The message 502 may be the wireless signal from which the device 104A harvests energy. The message 502 may or may not include data that is to be consumed or processed by the device 104A.

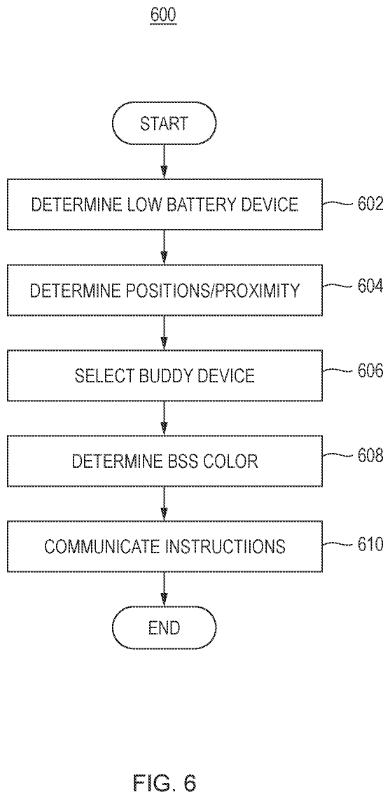

FIG. 6 is a flowchart of an example method 600 performed by the system 100 of FIG. 1. In particular embodiments, the access point 102 performs the method 600. By performing the method 600, the access point 102 determines and uses a buddy device to transmit wireless signals from which the device 104A harvests energy.

In block 602, the access point 102 determines whether the device 104A is a low battery device. The device 104A may communicate a battery level 302 to the access point 102. The access point 102 may determine from the battery level 302 whether the device 104A has low battery. The device 104A may also communicate a power type 304 to the access point 102. The access point 102 may determine, from the power type 304, how the device 104A receives electrical energy (e.g., harvest energy from wireless signals, plug-in, battery, Ethernet, etc.). The power type 304 may indicate that the device 104A harvests energy from wireless signals. The access point 102 may determine from this information that the device 104A has a low battery and should harvest energy from wireless signals to charge the battery.

In block 604, the access point 102 determines the positions 401 of access points 102 and devices 104 in the system 100. For example, the access point 102 may use RSSI or FTM exchanges to determine the positions 401 of the access points 102 and devices 104. The positions 401 may include coordinates that indicate the physical location or positioning of the access points 102 and devices 104 in the system 100. The access point 102 then determines the proximity 402 of the access point 102 and devices 104 to each other. The proximity 402 may indicate how close a device 104 is to another device 104 or access point 102.

In block 606, the access point 102 selects a device 104 or access point 102 as a buddy device that transmits wireless signals from which the device 104A harvests energy. The buddy device transmits the wireless signals in lieu of the access point 102 transmitting such signals. For example, the access point 102 may determine from the proximity 402 that the device 104A is far from the access point 102 and close to the device 104B. The access point 102 may determine that, due to how close the device 104A is to the device 104B, the device 104B should transmit wireless signals from which the device 104A harvests energy, rather than the access point 102. As a result, the access point 102 selects the device 104B as the buddy device.

In block 608, the access point 102 determines a BSS color 406 that should be used to transmit the wireless signals from which the device 104A harvests energy. The BSS color 406 may be different from another BSS color 408 used to make data transmissions in the system 100. In block 610, the access point 102 communicates an instruction 410 to the device 104B and/or the device 104A. The instruction 410 may instruct the device 104B to transmit wireless signals for the device 104A using the BSS color 406. The instruction 410 may also instruct the device 104A to harvest energy from wireless signals transmitted by the device 104B using the BSS color 406. In some embodiments, the instruction 410 also includes a schedule 409 that indicates when the wireless signals should be transmitted. In this manner, the access point 102 instructs the buddy device to transmit wireless signals in lieu of the access point 102 transmitting the wireless signals. By choosing a different BSS color 406 to transmit the wireless signals, the access point 102 also prevents the wireless signals from competing for bandwidth with data transmissions.

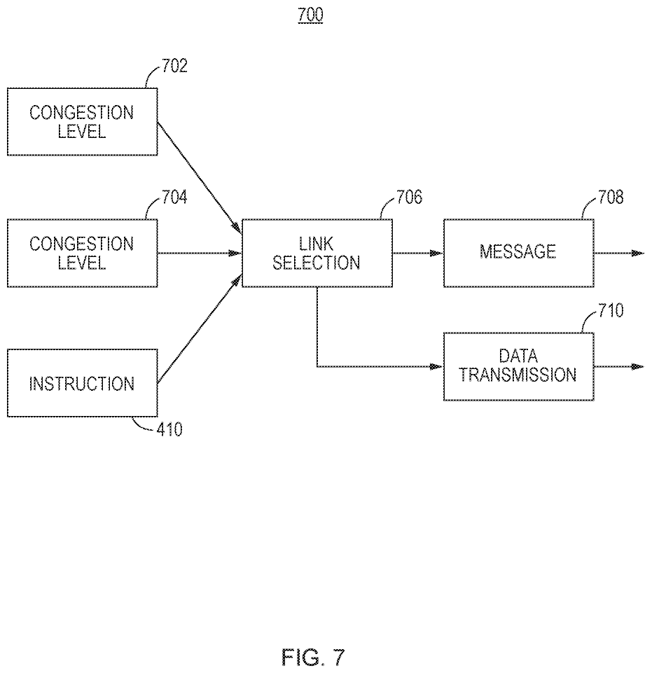

FIG. 7 illustrates an example operation 700 performed by the system 100 of FIG. 1. In particular embodiments, the device 104B performs the operation 700. By performing the operation 700, the device 104B selects a link to use to transmit the wireless signals from which the device 104A harvests energy.

In the example of FIG. 7, the device 104B supports multi-link operation (MLO) in which the device 104B may form multiple connections with a single or multiple access points. For example, one link or connection may be formed using a 2.4 gigaHertz (GHz) connection and another link or connection may be formed using a 5 GHz or 6 GHZ connection. The device 104B may determine congestion levels on one or more links, which may indicate an amount of traffic on these links in the system 100. In the example of FIG. 7, the device 104B determines a congestion level 702 for a first link (e.g., a 2.4 GHz link) and a congestion level 704 for a second link (e.g., a 5 GHz or 6 GHz link). The congestion level 702 and the congestion level 704 may indicate an amount of network traffic on the first link and the second link.

The device 104B makes a link selection 706 using the congestion levels 702 and 704. For example, the device 104B may select the link that has the least amount of congestion. The device 104B then transmits a message 708 using the selected link. The message 708 may be a wireless signal from which the device 104A harvests energy. In this manner, the device 104B transmits the message 708 using a link with the least amount of congestion, which reduces the impact of the bandwidth used to transmit the message 708 on other traffic.

In certain embodiments, the device 104B makes the link selection 706 according to the instruction 410 from the access point 102. For example, the access point 102 may determine the congestion on multiple links and then instruct the device 104B to transmit wireless signals using one of the links (e.g., the link with the least amount of congestion). The device 104B may select the link indicated in the instruction 410 and transmit the message 708 using that link.

In some embodiments, the device 104B also makes a data transmission 710. The data transmission 710 may not be made for energy harvesting purposes. The device 104B may make the data transmission over a link different from the link used to transmit the message 708. The data transmission 710 may also be made when the message 708 is being transmitted. In this manner, the device 104B makes the data transmission 710 along with transmitting the message 708 using different links.

In summary, the access point 102 determines and uses alternative devices and alternative BSS colors to transmit messages for energy harvesting purposes. For example, devices 104 in the network may report their battery levels 302 and positions 401 to the access point 102. The access point 102 may then determine which devices 104 need to harvest energy and the proximity 402 of those devices 104 to other devices 104 in the network. The access point 102 may use the proximity 402 to determine which devices 104 may serve as buddy devices and transmit messages to the devices 104 that need to harvest energy. The access point 102 may also determine a BSS color 406 that the buddy devices should use to transmit the messages used for energy harvesting. The buddy devices may then use that BSS color 406 to transmit the energy harvesting messages, while another BSS color 408 is used for data transmissions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
a memory; and
a processor communicatively coupled to the memory, the processor configured to:
determine, based on a proximity of a first device to a second device, that the second device should harvest energy from a message transmitted by the first device;
determine a first basic service set (BSS) color that the first device and the second device should use for the second device to harvest energy from the message; and
communicate, to the first device, an instruction to use the first BSS color when transmitting the message.

2. The access point of claim 1, wherein the processor is further configured to determine, based on a position of the second device, that the second device should avoid harvesting energy from a message transmitted by the access point.

3. The access point of claim 2, wherein determining that the second device should harvest energy from the message transmitted by the first device is in response to determining that the second device should avoid harvesting energy from the message transmitted by the access point.

4. The access point of claim 1, wherein the processor is further configured to determine a battery level of the second device, and wherein determining that the second device should harvest energy from the message is further based on the battery level of the second device.

5. The access point of claim 1, wherein the processor is further configured to use a second BSS color to make a data transmission, wherein the second BSS color is different from the first BSS color.

6. The access point of claim 5, wherein the data transmission is made when the message is being transmitted by the first device.

7. The access point of claim 1, wherein determining the first BSS color is in response to determining that the second device should harvest energy.

8. The access point of claim 1, wherein the processor is further configured to determine, based on a scheduled transmission, when the first device should transmit the message, wherein the instruction indicates when the first device should transmit the message.

9. A method comprising:
determining, by an access point and based on a proximity of a first device to a second device, that the second device should harvest energy from a message transmitted by the first device;
determining a first basic service set (BSS) color that the first device and the second device should use for the second device to harvest energy from the message; and
communicating, to the first device, an instruction to use the first BSS color when transmitting the message.

10. The method of claim 9, further comprising determining, based on a position of the second device, that the second device should avoid harvesting energy from a message transmitted by the access point.

11. The method of claim 10, wherein determining that the second device should harvest energy from the message transmitted by the first device is in response to determining that the second device should avoid harvesting energy from the message transmitted by the access point.

12. The method of claim 9, further comprising determining a battery level of the second device, and wherein determining that the second device should harvest energy from the message is further based on the battery level of the second device.

13. The method of claim 9, further comprising using a second BSS color to make a data transmission, wherein the second BSS color is different from the first BSS color.

14. The method of claim 13, wherein the data transmission is made when the message is being transmitted by the first device.

15. The method of claim 9, wherein determining the first BSS color is in response to determining that the second device should harvest energy.

16. The method of claim 9, further comprising determining, based on a scheduled transmission, when the first device should transmit the message, wherein the instruction indicates when the first device should transmit the message.

17. A device comprising:
a memory; and
a processor communicatively coupled to the memory, the processor configured to:
determine a first congestion level of a first link with a first access point;
determine a second congestion level of a second link with a second access point; and
based on comparing the first congestion level with the second congestion level, transmit, using the first link rather than the second link, a message from which another device harvests energy.

18. The device of claim 17, wherein the processor is further configured to receive, from at least one of the first access point or the second access point, an instruction to use the first link rather than the second link to transmit the message.

19. The device of claim 17, wherein the processor is further configured to make a data transmission using the second link.

20. The device of claim 19, wherein the data transmission is made when the message is being transmitted using the first link.
